(19) United States
(12) Patent Application Publication
(10) Pub. No.: US 2025/0245652 A1
(43) Pub. Date: Jul. 31, 2025

(54) METHOD AND SYSTEM FOR TRANSFERRING AUTHORITY TO A BENEFICIARY OF A BLOCKCHAIN ACCOUNT

(71) Applicant: Mastercard International Incorporated, Purchase, NY (US)

(72) Inventors: Jaipal Singh KUMAWAT, Sikar (IN); Avinash UPADHYAY, Noida (IN)

(73) Assignee: Mastercard International Incorporated, Purchase, NY (US)

(21) Appl. No.: 18/428,006

(22) Filed: Jan. 31, 2024

(51) Int. Cl. G06Q 20/38; G06Q 20/36; G06Q 20/40

(52) U.S. Cl. CPC G06Q 20/3829; G06Q 20/36; G06Q 20/3825; G06Q 20/389; G06Q 20/4016; G06Q 20/405

(57) ABSTRACT

A method for transferring authority of a blockchain wallet to a beneficiary includes storing a user blockchain account profile including a user blockchain wallet including a user private key and a user public key, user authentication preferences defining access to the user blockchain account profile, and one or more smart contracts defining one or more rules for the transfer of authority of the user blockchain wallet to one or more designated third-parties, monitoring user blockchain account activity, identifying a user blockchain account action that triggers at least one of the one or more rules, and transferring authority of the user blockchain account to at least one of the one or more designated third-parties based on the at least one triggered rule.

### FIELD

The present disclosure relates to the transfer of authority of a blockchain account to a beneficiary, specifically the use of a smart inheritance wallet having one or more associated rules defining the transfer of authority of the smart inheritance blockchain wallet to one or more designated third-party beneficiaries.

### BACKGROUND

Blockchains are used as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. Transactions typically operate in a blockchain by having cryptographic currency or other assets stored on the blockchain transferred from one electronic wallet to another, while the wallet owners or operators remain anonymous. The nature of blockchain assets is that the access to any given address to which an asset is associated is controlled based on possession of electronic credentials, often referred to as an electronic wallet, e-wallet, or simply “wallet.” As such, if the wallet is lost, discarded, or stolen, the associated assets often cannot be recovered by the rightful owner and may be used without their knowledge and permission. Furthermore, because of the anonymous nature of the blockchain, the consumer may be unable to prove their identity and ownership of a wallet, and thereby have little recourse if their wallet and/or associated asset is lost or stolen.

Thus, there is a need for a technological solution that enables a user to securely transfer authority and/or ownership of a blockchain wallet and/or any assets associated with that blockchain wallet in the event of one or more defined scenarios such as attempted fraudulent access to the blockchain wallet, loss of the blockchain wallet, inactivity of the blockchain wallet, etc.

### SUMMARY

The present disclosure provides a description of systems and methods for transferring authority of a blockchain wallet to a beneficiary. Embodiments of the present disclosure provide for the creation of a smart inheritance wallet to address the issue of transferring authority of a blockchain wallet and/or any assets associated therewith to a dependent in case of any security issues and/or suspicious activity. The smart inheritance wallet may use one or more smart contracts having one or more rules that can automatically transfer authority and access to assets associated with the smart inheritance wallet to one or more pre-defined beneficiaries. For example, the one or more rules can define conditions such as a threshold number of login attempts, a change in the user's IP address, and an inactivity time limit, etc. The smart contract of the smart inheritance wallet monitors user activity involving the smart inheritance wallet, e.g., access to the smart inheritance wallet and/or any transactions involving the smart inheritance wallet, that may trigger the one or more conditions defined by the one or more rules. In embodiments, if any of the conditions are triggered, the smart inheritance wallet can cause a notification to be sent to the user or a designated third-party for verification of the user activity and/or the smart inheritance wallet can initiate transfer of authority to the smart inheritance wallet to one or more designated third-parties, e.g., by updating the authentication credentials used for accessing the smart inheritance wallet to authentication credentials associated with the one or more designated third-parties. Thus, the systems and methods disclosed herein provide for a novel technical solution for transferring authority and/or access to a blockchain wallet and/or any assets associated with a blockchain wallet to one or more dependents in the event of one or more pre-defined conditions.

A method for transferring authority of a blockchain wallet to a beneficiary, includes: storing, in a memory of a processing server, a user blockchain account profile, the user blockchain account profile including a user blockchain wallet including a user private key and a user public key, user authentication preferences defining access to the user blockchain account profile, and one or more smart contracts defining one or more rules for the transfer of authority of the user blockchain wallet to one or more designated third-parties; monitoring, by a processor of the processing device, user blockchain account activity; identifying, by a processor of the processing device, a user blockchain account action that triggers at least one of the one or more rules; and transferring, by the processor of the processing device, authority of the user blockchain account to at least one of the one or more designated third-parties based on the at least one triggered rule.

A system for transferring authority of a blockchain wallet to a beneficiary includes a processing device configured to: store, in a memory, a user blockchain account profile, the user blockchain account profile including a user blockchain wallet including a user private key and a user public key, user authentication preferences defining access to the user blockchain account profile, and one or more smart contracts defining one or more rules for the transfer of authority of the user blockchain wallet to one or more designated third-parties; monitor, by a processor, user blockchain account activity; identifying, by the processor, a user blockchain account action that triggers at least one of the one or more rules; and transfer, by the processor, authority of the user blockchain account to at least one of the one or more designated third-parties based on the at least one triggered rule.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for transferring authority of a blockchain wallet to a beneficiary in accordance with exemplary embodiments;

FIG. 2 is a block diagram illustrating a processing server in the system of FIG. 1 for transferring authority of a blockchain wallet to a beneficiary in accordance with exemplary embodiments;

FIGS. 3A and 3B are a flow diagram illustrating a process for transferring authority of a blockchain wallet to a beneficiary in the system of FIG. 1 in accordance with exemplary embodiments;

FIG. 4 is a flow chart illustrating an exemplary method transferring authority of a blockchain wallet to a beneficiary in accordance with exemplary embodiments; and

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Transferring Authority of a Blockchain Wallet to a Beneficiary

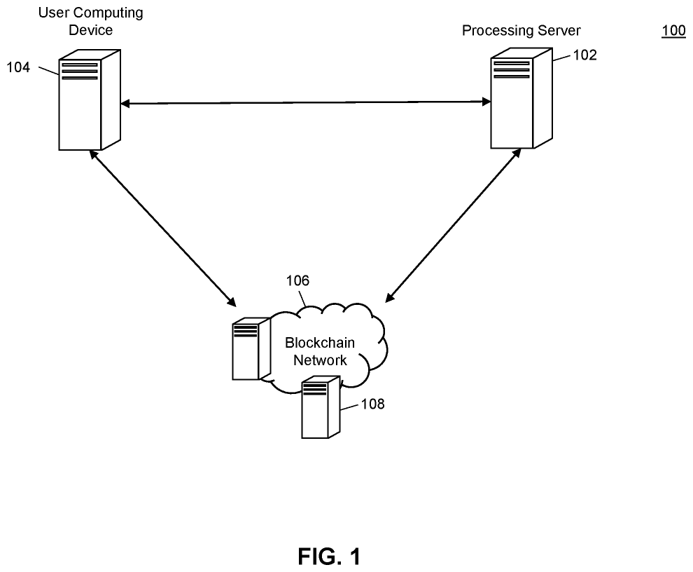

FIG. 1 illustrates a system 100 for transferring authority of a blockchain wallet to a beneficiary. The system 100 can include a processing server 102, user computing device 104, and blockchain network 106.

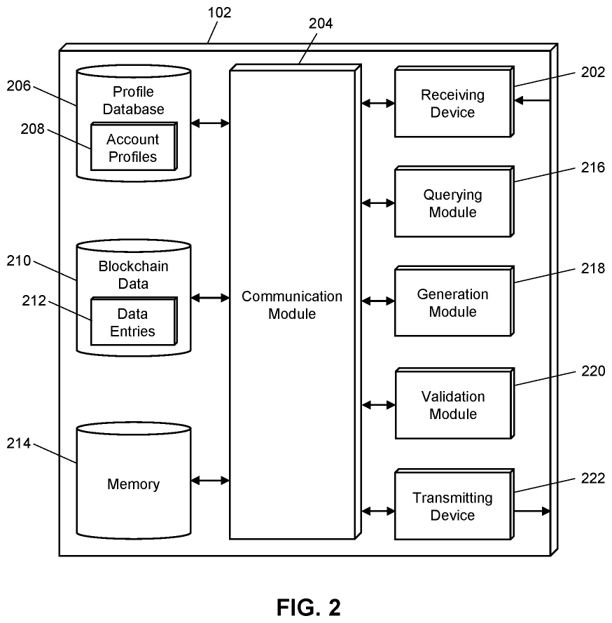

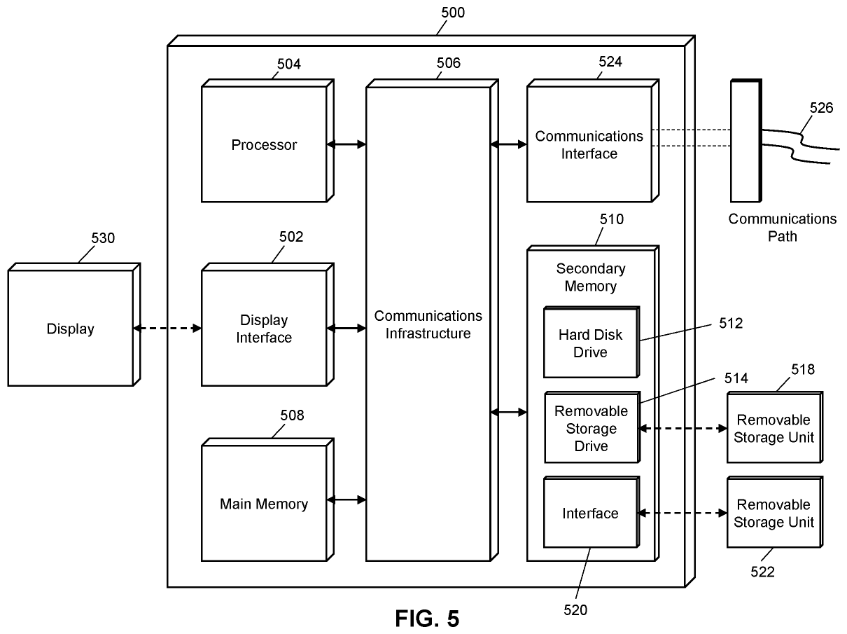

The processing server 102 can be a computing system, such as illustrated in FIG. 2 or 5, discussed in more detail below. For example, the processing server 102 may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as user computing device 104 and/or blockchain network nodes 108 via one or more communication methods, such as radio frequency, local area networks, wireless area networks, cellular communication networks, Bluetooth, the Internet, etc. In embodiments, the processing server 102 may be a computing system associated with a wallet service provider and/or a wallet storage provider. In embodiments, the processing server 102 may be a blockchain node 108 in the blockchain network 106.

The user computing device 104 may be a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as processing server 102 and/or blockchain network nodes 108 via one or more communication methods, such as radio frequency, local area networks, wireless area networks, cellular communication networks, Bluetooth, the Internet, etc. In embodiments, the user computing device 104 may be a computing system associated with a specific user of the blockchain network 106 and the user computing device 104 may store one or more blockchain wallets associated with that specific user. In embodiments, the user computing device 104 may be a blockchain node 108 in the blockchain network 106. While the user computing device 104 is illustrated separate from the processing server 102, it can be appreciated that in embodiments the user computing device 104 and the processing server 102 may be a single device.

In the system 100, a blockchain can be operated by a blockchain network 106. The blockchain network 106 can be comprised of a plurality of blockchain nodes 108. Each blockchain node 108 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. While only a single blockchain network 106 is illustrated, it can be appreciated that any number of blockchain networks 106 can be a part of the system 100. In some cases, a single blockchain network 106 can manage a single blockchain and, in other cases, a blockchain network 106 can manage multiple blockchains.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in each connected blockchain node 108 in a blockchain network 106 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 106 using the public key of the cryptographic key pair. In some cases, the term “blockchain wallet” can refer specifically to the private key. In other cases, the term “blockchain wallet” can refer to a computing device (e.g., processing server 102, the user computing device 104, and/or the blockchain nodes 108) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of data generated using the recipient's public key, and a data identification, e.g., a blockchain currency amount or asset identification, that is transferred or other data being stored. In some blockchain transactions, the transaction can also include one or more blockchain addresses of the sender where blockchain currency and/or data is currently stored (e.g., where the digital signature proves their access to such currency), as well as an address generated using the sender's public key for any change that is to be retained by the sender. Addresses to which cryptographic currency and/or data has been sent that can be used in future transactions are referred to as “output” addresses, as each address was previously used to capture output of a prior blockchain transaction, also referred to as “unspent transactions,” due to there being currency and/or data sent to the address in a prior transaction where that currency and/or data is still unspent or unused. In some cases, a blockchain transaction can also include the sender's public key, for use by an entity in validating the transaction. For the traditional processing of a blockchain transaction, such data can be provided to a blockchain node 108 in a blockchain network 106, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 108 in the blockchain network 106 before being added to the blockchain and distributed to all of the blockchain nodes 108 in the blockchain network 106, respectively, in traditional blockchain implementations. In cases where a blockchain data value cannot be related to a blockchain transaction, but instead the storage of other types of data, blockchain data values can still include or otherwise involve the validation of a digital signature.

As discussed above, the system 100 can include a processing server 102 and a user computing device 104. Each of the processing server 102 and the user computing device 104 can be a desktop computer, laptop computer, notebook computer, tablet computer, cellular phone, smart phone, smart watch, smart television, wearable computing device, implantable computing device, or other device configured to perform the functions discussed herein. Each of the processing server 102 and the user computing device 104 can be associated with a user that is interested in conducting a transaction on the blockchain network 106 and each of the processing server 102 and the user computing device 104 may be nodes in the blockchain network 106, e.g., blockchain nodes 108.

In embodiments, a user, e.g., a user associated with the user computing device 104, may wish to ensure that access to and/or authority over their blockchain wallet(s) and any associated assets stored on a blockchain can be transferred to one or more designated third-parties, in the event of one or more scenarios. In the system 100, a user, e.g., a user associated with the user computing device 104, creates a blockchain wallet including one or more rules defining conditions under which access to and/or authority over the blockchain wallet and any associated assets stored on a blockchain should be transferred to one or more designated third-parties. A blockchain wallet including one or more rules for the transfer of authority may be referred to herein as a smart inheritance blockchain wallet. The user, e.g., a user associated with the user computing device 104, can create the smart inheritance blockchain wallet via a platform, e.g., a website, a portal, etc., hosted by the processing server 102, and save the smart inheritance blockchain wallet and the one or more rules in a user blockchain account profile. The user blockchain account profile can be saved on the user's own device, e.g., the user computing device 104. The one or more rules may define a maximum number of user blockchain account profile login attempts, a maximum inactivity period, and/or an IP address change rule. The one or more rules may designate one or more third-parties if the conditions of the one or more rules are met. The one or more third-parties can include a back-up account of the user, a beneficiary of the user, a wallet service provider, e.g., the processing server 102, and/or any other suitable third-party capable of receiving authority of the user blockchain account profile and/or the smart inheritance wallet. The user, e.g., a user associated with the user computing device 104, may set up the one or more rules using one or more smart contracts. The creation of the smart inheritance blockchain wallet can include setting up a user blockchain account profile, e.g., a data file, on the processing server 102, to store the smart inheritance blockchain wallet and the one or more rules. In embodiment, the user blockchain account profile may be stored directly on the user computing device 104. The one or more rules may be user generated, selected from a list of possible rules developed by a blockchain wallet provider, e.g., the processing server 102, and/or blockchain network, e.g., the blockchain network 106, and/or based on past monitored use of the smart inheritance blockchain wallet. In embodiments, the processing server 102 can utilize one or more machine learning algorithms and/or neural networks to monitor the user's smart inheritance blockchain wallet activity to determine one or more user usage patterns. The one or more rules can be based or generated from the one or more user usage patterns. For example, the processing server 102 may determine that a specific user usually logs into their user blockchain account profile the same time every day and the processing server 102 may generate a rule that any login attempt outside that time of day or within a defined range including that time of day would trigger the rule and initiate transfer of the authority of the associated smart inheritance blockchain wallet. The user blockchain account profile, e.g., a data file, can also include one or more user authentication preferences defining access to the user blockchain account profile and/or the smart inheritance blockchain wallet. The one or more user authentication preferences can include one or more user authentication protocols such as, but not limited to, biometric authentication (e.g., fingerprint or facial recognition, etc.), genetic authentication (e.g., via DNA samples), multi-factor verification (e.g., one-time passwords (OTP) or hardware-based authentication keys, etc.). The smart inheritance blockchain wallet can be a multi-signature wallet requiring authorization from both the user, e.g., the user associated with the user computing device 104, and one or more of the designated third-party the beneficiaries to access the smart inheritance wallet. This ensures that no single party can unilaterally access the smart inheritance wallet. The processing server 102 may store the user blockchain account profile on a blockchain network, e.g., the blockchain network 106 and/or a different blockchain network. The processing server 102 can verify the one or more rules comply with any and all legal and/or regulatory requirements to ensure that the transfer of authority of the smart inheritance wallet and any associated assets is legally valid.

The processing server 102, e.g., using the one or more rules of the smart inheritance blockchain wallet, monitors the user's smart inheritance blockchain wallet activity. The user's smart inheritance blockchain wallet activity can include login and log-off activity, transaction history, user device location history, and/or any activity associated with the smart inheritance blockchain wallet and/or the user blockchain account profile. The processing server 102 can monitor the user's smart inheritance blockchain wallet activity continuously, periodically (e.g., capture and/or analyze user activity at defined time intervals), or randomly. In embodiments, the user computing device 104 can perform the monitoring functions described above. The processing server 102 can utilize one or more machine learning algorithms and/or neural networks to monitor the user's smart inheritance blockchain wallet activity and/or determine if the user's smart inheritance blockchain wallet activity triggers any of the one or more rules associated with the smart inheritance wallet.

The processing server 102 may transmit the one or more smart contracts including the one or more rules to the blockchain network 106 for inclusion on the blockchain. For example, the processing server 102 can generate a blockchain transaction including at least a digital signature generated using the user private key and the one or more smart contracts and transmit the blockchain transaction to the blockchain network 106 for confirmation and addition to a blockchain. The processing server 102 can monitor the blockchain for transactions involving the smart inheritance blockchain wallet, e.g., the user blockchain wallet. Further, the one or more rules can include rules governing user activity on the blockchain such as, but not limited to, a blockchain transaction amount limit, a blockchain transaction frequency limit, a blacklist of blockchain accounts on the blockchain, etc.

The processing server 102 may initiate a transfer of authority of the smart inheritance blockchain wallet, e.g., the user blockchain wallet, and/or the user blockchain account profile if the processing server 102 determines one or more of the rules has been triggered as a result of the monitored user blockchain account activity. For example, one of the rules may define a threshold, e.g., a maximum number, of login attempts to the user blockchain account profile in a defined period of time. If the processing server 102 determines that a login attempt to the user blockchain account profile exceeds the set threshold of login attempts, the processing server 102 may transfer authority of the user blockchain account profile and/or the smart inheritance blockchain wallet to one or more designated third-party beneficiaries as defined by the triggered rule. In embodiments, the processing server 102 may transfer the authority of the user blockchain account profile and/or the smart inheritance blockchain wallet to one or more designated third-party beneficiaries by transferring all the assets stored in the blockchain, e.g., the blockchain network 106, associated with the smart inheritance blockchain wallet, e.g., the user blockchain wallet, to a wallet associated with the one or more designated third-parties. For example, the processing server 102 can execute a query on the blockchain, e.g., the blockchain network 106, to identify all blockchain data values, e.g., unspent transaction outputs (UTXOs), associated with the smart inheritance blockchain wallet, e.g., the user blockchain wallet. The processing server 102 may consolidate all the identified blockchain data values into a single blockchain data value, e.g., a single UTXO, to facilitate an easier transfer of the assets to the one or more designated third-parties. For example, the processing server 102 can identify all unspent transaction outputs (UTXOs) on the blockchain associated with the smart inheritance blockchain wallet, e.g., the user blockchain wallet, and generate a new blockchain transaction combining all the identified UTXOs and submitting the new blockchain transaction to the blockchain network 106 for validation and addition to the blockchain. In embodiments, the processing server 102 can tokenize all the assets associated with the smart inheritance blockchain wallet, e.g., the user blockchain wallet. For example, the processing server 102 can identify all blockchain data values, e.g., UTXOs, associated with the smart inheritance blockchain wallet, e.g., the user blockchain wallet stored on the blockchain, and tokenize the assets associated with the blockchain data values. The processing server 102 can transfer the tokens to the to a wallet associated with the one or more designated third-parties or submit a new blockchain transaction to the blockchain, e.g., the blockchain network 106, including the tokens for validation and addition to the blockchain. In embodiments, the transfer of the authority of the user blockchain account profile and/or the smart inheritance blockchain wallet can include the processing server 102 transferring the smart inheritance wallet and/or any associated assets from a first blockchain associated with the smart inheritance blockchain wallet to a different blockchain associated with a wallet of the one or more designated third-parties. In embodiments, the one or more tokens representing the assets associated with the smart inheritance wallet can be non-fungible tokens (NFTs). Thus, the disclosed methods and systems enable interoperability with multiple blockchain networks to offer users the flexibility to choose the blockchain that aligns with their preferences and security requirements.

In embodiments, the processing server 102 may transfer the authority of the user blockchain account profile and/or the smart inheritance blockchain wallet to one or more designated third-party beneficiaries by updating the user authentication preferences of the user blockchain account profile to authentication preferences of the at least one of the one or more designated third-parties. The updating of the user authentication preferences can include, but is not limited to, updating the authentication preferences according to the one or more rules (e.g., a saved username and/or password associated with the one or more designated third-parties), sending a notification to the one or more designated third-parties requiring the one or more designated third-parties to login and update the user authentication preferences, sending a notification to the one or more designated third-parties with a temporary username and/or password to the one or more designated third-parties, etc. For example, the processing server 102 may change the username and/or password for the user blockchain account profile and send a notification to the one or more designated third-parties with the updated username and/or password. It can be appreciated that the processing server can send more than one notification to the same designated beneficiary, e.g., a first notification with an updated username and a second notification with the updated password. In embodiments, the processing server 102 may send all the contents of the user blockchain account profile to the one or more designated third-parties and/or may send a subset of the contents of the user blockchain account profile, e.g., the cryptographic key pair associated with the smart inheritance wallet to the one or more designated third-parties.

In embodiments, prior to transferring the authority of the smart inheritance blockchain wallet, e.g., the user blockchain wallet, and/or the user blockchain account profile, the processing server 102 may generate and transmit one or more notifications of the triggered one or more rules. The notification can include details about the identified user blockchain account activity that triggered the at least one of the one or more rules and an indication of suspected fraudulent activity based on the triggered at least one rule of the one or more rules. For example, the notification may identify the time and location of a failed login attempt and the reason for the notification being the failed login attempt exceeded a set threshold of login attempts. In embodiment, the user blockchain account profile can include one or more device identifiers associated with user and/or the one or more designated third-parties identifying one or more devices and/or secure storage locations associated with the user and/or each of the one or more designated third-parties. The processing server 102 can transmit the notifications to the device identified by the one or more device identifiers. For example, the user blockchain account profile can identify a sole designated beneficiary and include an associated a phone number, an e-mail address, a secure storage address, an IP address, an IMEI number, or any other suitable device identifier. In embodiments, the notification of the triggered one or more rules can include a grace period to allow the user, e.g., via a user back-up device, and/or the one or more designated third-parties to approve and/or deny the user account activity that triggered the one or more rules. For example, the notification may be sent to a device associated with the user and the user can approve the user account activity as valid, e.g., the user forgot their password and does not wish authority to be transferred as a result of their valid login attempts. The grace period may include a pre-defined time in which the user and/or the one or more designated third-parties can respond to the notification before authority of the smart inheritance blockchain wallet, e.g., the user blockchain wallet, and/or the user blockchain account profile, is transferred.

The methods and systems discussed herein provide for the transfer of authority, e.g., ownership, of a blockchain wallet and/or any assets associated with that blockchain wallet in the event of one or more defined conditions as governed by one or more smart contracts. The result is that users can have peace of mind knowing that their digital assets are protected and can be seamlessly transferred to their designated beneficiaries in case of any security threats or emergencies. The methods and systems discussed herein provide a secure and efficient way to handle inheritance and safeguard cryptocurrency holdings, ensuring that they can be passed on to their intended recipients in a trustworthy and automated manner.

### Processing Server

FIG. 2 illustrates an embodiment of the processing server 102. It will be apparent to persons having skill in the relevant art that the embodiment of the computing system 200 illustrated in FIG. 2 is provided as illustration only and cannot be exhaustive to all possible configurations of the computing system 200 suitable for performing the functions as discussed herein. For example, the computer system 500 illustrated in FIG. 5 and discussed in more detail below can be a suitable configuration of the processing server 102.

The processing server 102 can include a receiving device 202. The receiving device 202 can be configured to receive data over one or more networks via one or more network protocols. In some instances, the receiving device 202 can be configured to receive data from blockchain nodes of the blockchain network 106, user computing device 104, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes of the blockchain network 106, which can be superimposed or otherwise encoded with blockchain data entries, blocks, blockchain transactions, transaction notifications, etc. The receiving device 202 can also be configured to receive data signals electronically transmitted by the user computing device 104 that can be superimposed or otherwise encoded with user authentication preferences, login request messages, one or more smart contracts including one or more rules, one or more designated third-parties, device identifiers, data messages, notifications, notification response messages, private keys, public keys, digital signatures, new blockchain transactions, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, transaction module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include profile database 206. The profile database 206 can be configured to store data using suitable data formatting methods and schema and can be any suitable type of memory, such as read-only memory, random access memory, etc. The profile database 206 can include one or more account profiles 208. The account profiles 208, e.g., user blockchain account profile, can include at least a user blockchain wallet including a user private key and a user public key, user authentication preferences defining access to the user blockchain account profile (e.g., account profile 208), and one or more smart contracts defining one or more rules for the transfer of authority of the user blockchain wallet to one or more designated third-parties. The user authentication preferences can include, for example, a password, biometric authentication, multi-factor authentication, a hardware-based authentication keys, and/or any other suitable digital account authentication protocol, etc. The one or more rules can include, for example, a maximum number of user blockchain account profile login attempts, a maximum inactivity period, and/or an IP address change rule. The IP address change rule can define a minimum amount of time a user's IP address must remain static. The user blockchain account profile (e.g., account profile 208) can further include a user device identification identifying a user device. The user device identification can identify a user device associated with the user of the user blockchain wallet and/or one or more of the designated third-parties included in the user blockchain account profile (e.g., account profile 208).

The processing server 102 can also include blockchain data 210, which can be stored in a memory 214 of the processing server 102 or stored in a separate area within the processing server 102 or accessible thereby. The blockchain data 210 can include data associated with one or more blockchains, such as blockchain wallet data for a plurality of blockchain wallets. For example, the blockchain data 210 can include cryptographic key pairs, unspent transaction outputs, exchange rate data, wallet balances, and other data.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, configuration keys, cryptographic keys including public keys and/or private keys, communication data, blockchain algorithms and data, e.g., blockchain data 210, account profiles, e.g., account profiles 208, etc.

The processing server 102 can include a querying module 216. The querying module 216 can be configured to execute queries on databases to identify information. The querying module 216 can receive one or more data values or query strings and can execute a query string based thereon on an indicated database, such as the profile database 206 and/or the blockchain data 210 of the processing server 102 to identify information stored therein. The querying module 216 can then output the identified information to an appropriate engine or module of the processing server 102 as necessary. The querying module 216 can, for example, execute a query on blockchain data 210 to identify any transactions involving a user blockchain wallet.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate encryption keys, blockchain transactions, digital signatures, destination addresses, notifications, data messages, blockchain wallets, smart contracts, user blockchain account profiles, user blockchain account activity profiles etc.

The processing server 102 can also include a validation module 220. The validation module 220 can be configured to perform data validations and verifications for the processing server 102 as part of the functions discussed herein. The validation module 220 can receive instructions as input, can perform data validations or verification as instructed, and can output a result of the data validations or verifications to one or more modules of the processing server 102. In some cases, the input can include the data to be validated or verified and/or data to be used in the validation or verification. In other cases, the validation module 220 can be configured to identify such data, such as in the blockchain data 206 and/or memory 214. The validation module 220 can be configured to, for example, verify one or more blockchain transactions comply with one or more rules, verify that a blockchain transaction conforms to past user blockchain account activity, verify that blockchain account activity complies with one or more rules, verify that blockchain account activity conforms to past user blockchain account activity, etc.

The processing server 102 can also include a transmitting device 222. The transmitting device 222 can be configured to transmit data over one or more networks via one or more network protocols. In some instances, the transmitting device 222 can be configured to transmit data to blockchain nodes of the blockchain network 106, user computing device 104, and other systems and entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes of the blockchain network 106 that can be superimposed or otherwise encoded with new blockchain transactions, requests for blockchain data, etc. The transmitting device 222 can also be configured to electronically transmit data signals to the user computing device 104 that are superimposed or otherwise encoded with new blockchain transactions, blockchain data requests, notifications, etc.

### Process for Transferring Authority of a Blockchain Wallet to a Beneficiary

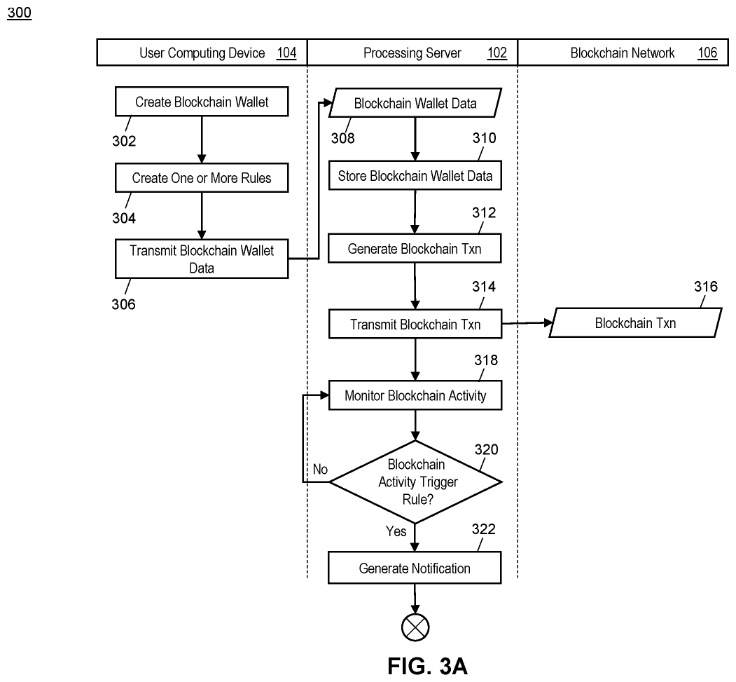

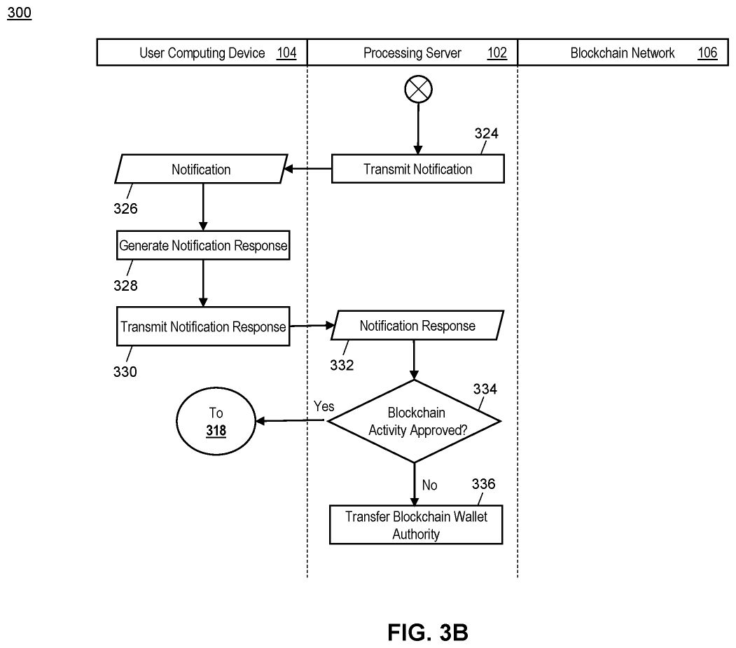

FIGS. 3A and 3B illustrate a process in the system 100 of FIG. 1 for transferring authority of a blockchain wallet to a beneficiary.

In step 302, a user, e.g., a user associated with the user computing device 104, creates a blockchain wallet. The user, e.g., a user associated with the user computing device 104, can create the smart inheritance wallet via a platform, e.g., a website, a portal, etc., hosted by the processing server 102.

In step 304, the user, e.g., a user associated with the user computing device 104, creates one or more rules defining conditions under which access to and/or authority over the smart inheritance blockchain wallet and any associated assets stored on a blockchain, e.g., a blockchain associated with the blockchain network 106, should be transferred to one or more designated third-parties. The one or more rules may designate one or more third-parties if the conditions of the one or more rules are met. The one or more third-parties can include a back-up account of the user, a beneficiary of the user, a wallet service provider, e.g., the processing server 102, or any other suitable third-party capable of receiving authority of the user blockchain account profile and/or the smart inheritance wallet. The user, e.g., a user associated with the user computing device 104, may set up the one or more rules using one or more smart contracts.

In step 306, the user, e.g., a user associated with the user computing device 104, transmits blockchain wallet data to the processing server 102. For example, the user the blockchain wallet data can include a smart inheritance blockchain wallet account number and/or associated cryptographic keys, e.g., a private key and public key pair, and the one or more smart contracts comprising the one or more rules. In embodiments, transfer of the blockchain wallet data to the processing server 102 may not be necessary as the user, e.g., a user associated with the user computing device 104, may create the smart inheritance blockchain wallet and the one or more rules via a platform, e.g., a website, a portal, etc., hosted by the processing server 102. In step 308, the processing server 102 receives the blockchain wallet data.

In step 310, the processing server 102 stores the blockchain wallet data. For example, the processing server 102 stores the smart inheritance wallet and the one or more rules in a user blockchain account profile, e.g., account profile 208, of the user, e.g., the user associated with the user computing device 104.

In step 312, the processing server 102 generates a blockchain transaction. The blockchain transaction can include at least a digital signature generated using the user private key and the one or more smart contracts comprising the one or more rules. In step 314, the processing server 102 transmits the blockchain transaction to the blockchain network 106 for confirmation and addition to a blockchain. In step 316, one or more blockchain nodes 108 of the blockchain network receive the blockchain transaction, confirm the blockchain transaction, and add the blockchain transaction to the blockchain.

In step 318, the processing server 102 monitors user blockchain account activity. For example, the processing server 102 monitors use of the smart inheritance blockchain wallet on the blockchain network 106 using the one or more smart contracts comprising the one or more rules.

In step 320, the processing server 102 determines if any user blockchain account activity triggers the one or more rules, e.g., the one or more smart contracts are triggered. For example, the processing server 102 may identify a blockchain transaction including the smart inheritance wallet on the blockchain network 106 triggers at least one of the one or more rules. The processing server 102 may determine determines if any user blockchain account activity triggers the one or more rules, e.g., the one or more smart contracts are triggered by generating a user blockchain account activity profile based on past user blockchain account activity and compare the monitored user blockchain account activity to the user blockchain account activity profile. If the processing server does determine that a user activity triggers the one or more rules, the process 300 proceeds to step 322. If the processing server does not determine that a user activity triggers the one or more rules, the process 300 proceeds to step 318 and continues to monitor user blockchain account activity.

In step 322, the processing server 102 generates a notification. The notification can include details about the identified user blockchain account activity that triggered the at least one of the one or more rules and an indication of suspected fraudulent activity based on the triggered at least one rule of the one or more rules. For example, the notification may identify the time and location of a failed login attempt and the reason for the notification being the failed login attempt exceeded a set threshold of login attempts. In embodiment, the user blockchain account profile, e.g., account profile 208, can include one or more device identifiers associated with user and/or the one or more designated third-parties identifying one or more devices and/or secure storage locations associated with the user and/or each of the one or more designated third-parties. The processing server 102 can transmit the notifications to the device identified by the one or more device identifiers.

In step 324, the processing server 102 transmits the notification to the device identified in the user blockchain account profile, e.g., the user computing device 104. In step 326, the device identified in the user blockchain account profile, e.g., the user computing device 104, receives the notification. In step 328, the user computing device 104 generates a notification response message in response to the notification. For example, the notification response message can include an indication of approval or denial of the user blockchain account activity that triggered the at least one of the one or more rules. In step 330, the user computing device 104 transmits the notification response message to the processing server 102.

In step 332, the processing server 102 receives the notification response message. In step 334, the processing server 102 determines if the notification response message includes an indication of approval or a denial of the user blockchain account activity that triggered the at least one of the one or more rules. If the notification response message includes an indication of approval of the user blockchain account activity that triggered the at least one of the one or more rules, the process proceeds to step 318. If the notification response message includes an indication of denial of the user blockchain account activity that triggered the at least one of the one or more rules, e.g., confirmation to activity is fraudulent, the process proceeds to step 336.

In step 336, the processing server 102 transmits authority of the user blockchain account, e.g., of the smart inheritance blockchain wallet, to at least one of the one or more designated third-parties based on the at least one triggered rule. For example, the processing server 102 may update the user authentication preferences for the user blockchain account profile (e.g., account profile 208) to correspond to authentication preferences of the at least one of the one or more designated third-parties.

### Exemplary Method for Transferring Authority of a Blockchain Wallet to a Beneficiary

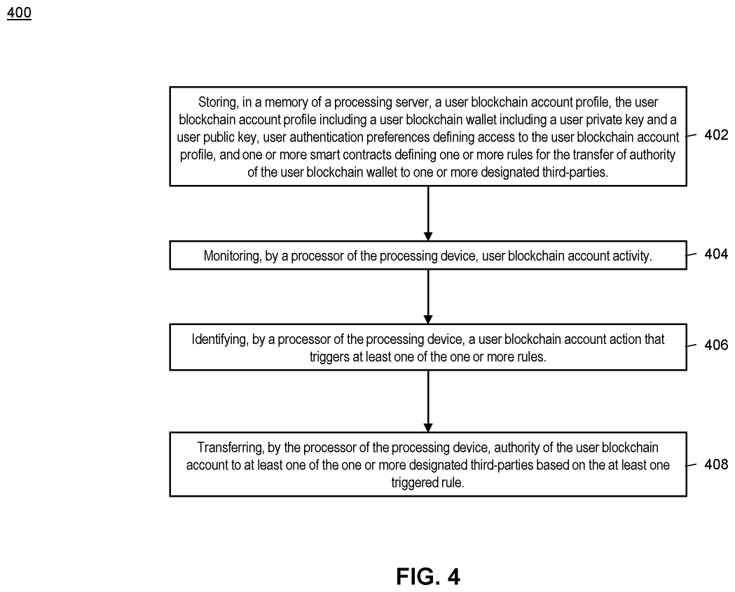

FIG. 4 illustrates a method 400 for transferring authority of a blockchain wallet to a beneficiary.

In step 402, a user blockchain account profile is stored in a memory (e.g., the profile database 206) of a processing server (e.g., processing server 102). The user blockchain account profile (e.g., account profile 208) includes at least a user blockchain wallet including a user private key and a user public key, user authentication preferences defining access to the user blockchain account profile (e.g., account profile 208), and one or more smart contracts defining one or more rules for the transfer of authority of the user blockchain wallet to one or more designated third-parties. The user authentication preferences can include, for example, a password, biometric authentication, multi-factor authentication, a hardware-based authentication keys, and/or any other suitable digital account authentication protocol, etc. The one or more rules can include, for example, a maximum number of user blockchain account profile login attempts, a maximum inactivity period, and/or an IP address change rule. The IP address change rule can define a minimum amount of time a user's IP address must remain static. The user blockchain account profile (e.g., account profile 208) can further include a user device identification identifying a user device. The user device identification can identify a user device associated with the user of the user blockchain wallet and/or one or more of the designated third-parties included in the user blockchain account profile (e.g., account profile 208). The processor (e.g., the generation module 218) of the processing server (e.g., processing server 102) can generate a blockchain transaction including at least a digital signature generated using the user private key and the one or more smart contracts included in the user blockchain account profile (e.g., account profile 208). The transmitter (e.g., the transmitting device 222) of the processing server (e.g., processing server 102) can transmit the blockchain transaction to a blockchain network for confirmation and addition to a blockchain (e.g., a blockchain associated with the blockchain network 106).

In step 404, the processor (e.g., the querying module 216) of the processing server (e.g., processing server 102) can monitor user blockchain account activity on a blockchain (e.g., a blockchain associated with the blockchain network 106). Monitoring user blockchain account activity can include monitoring by the processor (e.g., the querying module 216) of the processing server (e.g., processing server 102) a blockchain (e.g., a blockchain associated with the blockchain network 106) for transactions involving the user blockchain wallet stored in the user blockchain account profile (e.g., account profile 208). For example, the processor (e.g., the querying module 216) of the processing server (e.g., processing server 102) can query the blockchain (e.g., a blockchain associated with the blockchain network 106) for transactions that include the user blockchain wallet stored in the user blockchain account profile (e.g., account profile 208). The processor (e.g., the querying module 216) of the processing server (e.g., processing server 102) can query the blockchain (e.g., a blockchain associated with the blockchain network 106) continuously or periodically at defined time intervals. In embodiments where the processing server (e.g., processing server 102) is a blockchain node (e.g., a blockchain node 108) in the blockchain network (e.g., the blockchain network 106), the processor (e.g., the querying module 216) of the processing server (e.g., processing server 102) can query the copy of the blockchain stored on the processing server (e.g., the blockchain data 210).

In step 406, the processor (e.g., the validation module 220) of the processing server (e.g., processing server 102) can identify a user blockchain account action that triggers at least one of the one or more rules stored in the user blockchain account profile (e.g., account profile 208). The user blockchain account action that triggers the at least one of the one or more rules can be a blockchain transaction on the blockchain (e.g., a blockchain associated with the blockchain network 106). Identifying the user blockchain account action that triggers at least one of the one or more rules can include the processor (e.g., the generation module 218) of the processing server (e.g., processing server 102) generating a user blockchain account activity profile based on past user blockchain account activity. The processor (e.g., the validation module 220) of the processing server (e.g., processing server 102) can compare the monitored user blockchain account activity to the user blockchain account activity profile and determine the user blockchain account action deviates from the user blockchain account activity profile.

In step 408, the processor (e.g., the generation module 218) of the processing server (e.g., processing server 102) can transfer authority of the user blockchain account to at least one of the one or more designated third-parties based on the at least one triggered rule. For example, the processor (e.g., the generation module 218) of the processing server (e.g., processing server 102) can update the user authentication preferences stored in the user blockchain account profile (e.g., account profile 208) to correspond to authentication preferences of the at least one of the one or more designated third-parties.

The method 400 can further include: the processor (e.g., the generation module 218) of the processing server (e.g., processing server 102) generating, a notification, the notification including details about the identified user blockchain account activity that triggered the at least one of the one or more rules and an indication of suspected fraudulent activity based on the triggered at least one rule of the one or more rules. The notification can include a grace period that defines a time period during which a notification response message must be received by the processing server (e.g., processing server 102). The method 400 can also include the transmitter (e.g., the transmitting device 222) of the processing server (e.g., processing server 102) transmitting the notification to the user device (e.g., the user device identified by the user device identification included in the user blockchain account profile (e.g., account profile 208). The method 400 can further include the receiver (e.g., receiving device 202) of the processing server (e.g., processing server 102) receiving, from the user device (e.g., user computing device 104), a notification response message approving or denying the identified user blockchain account activity.

### Computer System Architecture

FIG. 5 illustrates a computer system 500 in which embodiments of the present disclosure, or portions thereof, can be implemented as computer-readable code. For example, the processing server 102, blockchain nodes 108 of the blockchain network 106, and computing devices 110 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc. Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for transferring authority of a blockchain wallet to a beneficiary. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for transferring authority of a blockchain wallet to a beneficiary, comprising:
storing, in a memory of a processing device, a user blockchain account profile, the user blockchain account profile including a user blockchain wallet including a user private key and a user public key, user authentication preferences defining access to the user blockchain account profile, and one or more smart contracts defining one or more rules for the transfer of authority of the user blockchain wallet to one or more designated third-parties;
monitoring, by a processor of the processing device, user blockchain account activity;
identifying, by the processor of the processing device, a user blockchain account action that triggers at least one of the one or more rules; and
transferring, by the processor of the processing device, authority of the user blockchain account to at least one of the one or more designated third-parties based on the at least one triggered rule.

2. The method of claim 1, wherein the transferring the authority of the user blockchain account to the least one of the one or more designated third-parties includes:
updating, by the processor of the processing device, the user authentication preferences to correspond to authentication preferences of the at least one of the one or more designated third-parties.

3. The method of claim 1, further comprising:
generating, by the processor of the processing device, a blockchain transaction including at least a digital signature generated using the user private key and the one or more smart contracts; and
transmitting, by a transmitting device of the processing server, the blockchain transaction to a blockchain network for confirmation and addition to a blockchain.

4. The method of claim 3, wherein the monitoring of the user blockchain account activity includes:
monitoring, by the processor of the processing device, the blockchain for transactions involving the user blockchain wallet,
wherein the user blockchain account action that triggered the at least one of the one or more rules is a blockchain transaction.

5. The method of claim 1, wherein the user blockchain account profile further includes a user device identification identifying a user device, the method further comprising:
generating, by the processor of the processing device, a notification, the notification including details about the identified user blockchain account activity that triggered the at least one of the one or more rules and an indication of suspected fraudulent activity based on the triggered at least one rule of the one or more rules; and
transmitting, by the transmitting device of processing device, the notification to the user device.

6. The method of claim 5, further comprising:
receiving, by a receiving device of the processing device from the user device, a notification response message approving or denying the identified user blockchain account activity.

7. The method of claim 5, wherein the notification includes a grace period, the grace period being a pre-defined time period during which a notification response message must be received.

8. The method of claim 1, wherein the user authentication preferences include at least one of: a password, biometric authentication, multi-factor authentication, and hardware-based authentication keys.

9. The method of claim 1, wherein the one or more rules include at least one of: a maximum number of user blockchain account profile login attempts, a maximum inactivity period, and an IP address change rule.

10. The method of claim 2, further comprising:
generating, by the processor of the processing device, a user blockchain account activity profile based on past user blockchain account activity;
wherein the identifying the user blockchain account action that triggers at least one of the one or more rules includes:
comparing, by the processor of the processing device, the monitored user blockchain account activity to the user blockchain account activity profile; and
determining, by the processor of the processing device, the user blockchain account action deviates from the user blockchain account activity profile.

11. A system for transferring assets stored on a blockchain to a beneficiary, comprising:
a processing device configured to:
store, in a memory, a user blockchain account profile, the user blockchain account profile including a user blockchain wallet including a user private key and a user public key, user authentication preferences defining access to the user blockchain account profile, and one or more smart contracts defining one or more rules for the transfer of authority of the user blockchain wallet to one or more designated third-parties;
monitor, by a processor, user blockchain account activity;
identifying, by the processor, a user blockchain account action that triggers at least one of the one or more rules; and
transfer, by the processor, authority of the user blockchain account to at least one of the one or more designated third-parties based on the at least one triggered rule.

12. The system of claim 11, wherein the transferring the authority of the user blockchain account to the least one of the one or more designated third-parties includes:
the processor of the processing device further configured to update the user authentication preferences to correspond to authentication preferences of the at least one of the one or more designated third-parties.

13. The system of claim 11, further comprising:
the processor of the processing device further configured to generate a blockchain transaction including at least a digital signature generated using the user private key and the one or more smart contracts; and
a transmitting device of the processing device configured to transmit the blockchain transaction to a blockchain network for confirmation and addition to a blockchain.

14. The system of claim 13, wherein the monitoring of the user blockchain account activity includes:
the processor of the processing device further configured to monitor the blockchain for transactions involving the user blockchain wallet,
wherein the user blockchain account action that triggered the at least one of the one or more rules is a blockchain transaction.

15. The system of claim 11, wherein the user blockchain account profile further includes a user device identification identifying a user device, the system further comprising:
the processor of the processing device further configured to generate a notification, the notification including details about the identified user blockchain account activity that triggered the at least one of the one or more rules and an indication of suspected fraudulent activity based on the triggered at least one rule of the one or more rules; and
a transmitting device of processing device further configure to transmit the notification to the user device.

16. The system of claim 15, further comprising:
a receiving device of the processing device configured to receive from the user device, a notification response message approving or denying the identified user blockchain account activity.

17. The system of claim 15, wherein the notification includes a grace period, the grace period being a pre-defined time period during which a notification response message must be received.

18. The system of claim 11, wherein the user authentication preferences include at least one of: a password, biometric authentication, multi-factor authentication, and hardware-based authentication keys.

19. The system of claim 11, wherein the one or more rules include at least one of: a maximum number of user blockchain account profile login attempts, a maximum inactivity period, and an IP address change rule.

20. The system of claim 12, further comprising:
the processor of the processing device further configured to generate a user blockchain account activity profile based on past user blockchain account activity;
wherein the identifying the user blockchain account action that triggers at least one of the one or more rules includes:
the processor of the processing device further configured to compare the monitored user blockchain account activity to the user blockchain account activity profile; and
the processor of the processing device further configured to determine the user blockchain account action deviates from the user blockchain account activity profile.
